(19) United States
(12) Patent Application Publication
(10) Pub. No.: US 2015/0177372 A1
(43) Pub. Date: Jun. 25, 2015

(54) MIR Two Dimensional Scanner

(71) Applicant: David I. Poisner, Carmichael, CA (US)

(72) Inventor: David I. Poisner, Carmichael, CA (US)

(21) Appl. No.: 14/133,958

(22) Filed: Dec. 19, 2013

(51) Int. Cl. G01S 13/86

(52) U.S. Cl. CPC G01S 13/86

(57) ABSTRACT

In accordance with some embodiments, a micro impulse radar (MIR) hand scanner enables scanning of structures concealed by conventional wall, floor, or ceiling surfaces such as wall board, plywood, plaster, brick siding and the like. By simply scanning a wand across a wall surface one can determine not only what is within the wall but may also gain information about the types of materials are involved and their specific location within the wall relative to the wall surface. This may assist in identifying exactly what it is behind the wall.

### BACKGROUND

This relates generally to scanning to detect structures within building walls, floors or ceilings.

Existing stud finders tend to be either inexpensive and ineffective or expensive and less than optimally effective. Stud finders may be very low cost items and may cost more than one thousand dollars. Even the most expensive detectors are unable to precisely indicate size, shape and distance within the wall as well as the different materials. Thus different types of pipe and conduit cannot readily be distinguished with these existing technologies. Existing radar based scanning generates high frequency radio waves to detect objects within walls by performing a single scan in one dimension.

### BRIEF DESCRIPTION OF THE DRAWINGS

Some embodiments are described with respect to the following figures:

FIG. 1 is a top plan view of one embodiment;

FIG. 2 is a bottom plan view of one embodiment;

FIG. 3 is a circuit diagram for one embodiment; and

FIG. 4 is a flow chart for one embodiment.

### DETAILED DESCRIPTION

In accordance with some embodiments, a micro impulse radar (MIR) hand scanner enables scanning of structures concealed by conventional wall, ceiling, or floor surfaces, such as wall board, plywood, plaster, brick siding and the like. By simply scanning a wand across a wall surface one can determine not only what is within the wall but may also gain information about the types of materials are involved and their specific location within the wall relative to the wall surface. This may assist in identifying exactly what it is behind the wall. The user may move the scanner in two dimensions. The scanner detects movement in two dimensions. It may also include user interface capability associated with the two dimensions of movement.

Micro impulse radar involves transmitting short, high frequency pulses and measuring the resulting reflections. The micro impulse radar uses low power, ultra wide band pulses to detect objects at a distance. Many pulses are sent and in some cases the beam is adjusted across a wide two or three dimensional space. It allows the collection of information about the size, shape and distance within the wall as well as information about the different types of materials that make up the structures within the wall.

A MIR transceiver may be used to find objects embedded in the walls such as water pipes, gas pipes, drain pipes, electrical conduit, electrical wires, heating ventilation and air conditioning ducts, beams, studs and even animals. This MIR derived information may allow many people, including plumbers, electricians, and heating ventilation and air conditioning technicians, to make better decisions about the nature and locations of concealed structures.

As the wand moves across the wall or floor or ceiling, an imaging technology is used to determine the precise direction of movement in two dimensions, and the speed of the movement. This imaging technology may incorporate mechanisms found in an optical mouse. The current position along the surface is calculated from the movement. The movement details are then used to determine if a sufficient number of radar pulses have been issued for the distance moved, and to properly position the displayed results.

In addition, for the technology to work at reasonably low cost, it is advantageous to provide feedback to the user so that the user does not move the wand too slowly or too quickly. Thus, in some cases, audible or visual feedback may be provided to cause the operator to move the wand within a reasonably effective speed range.

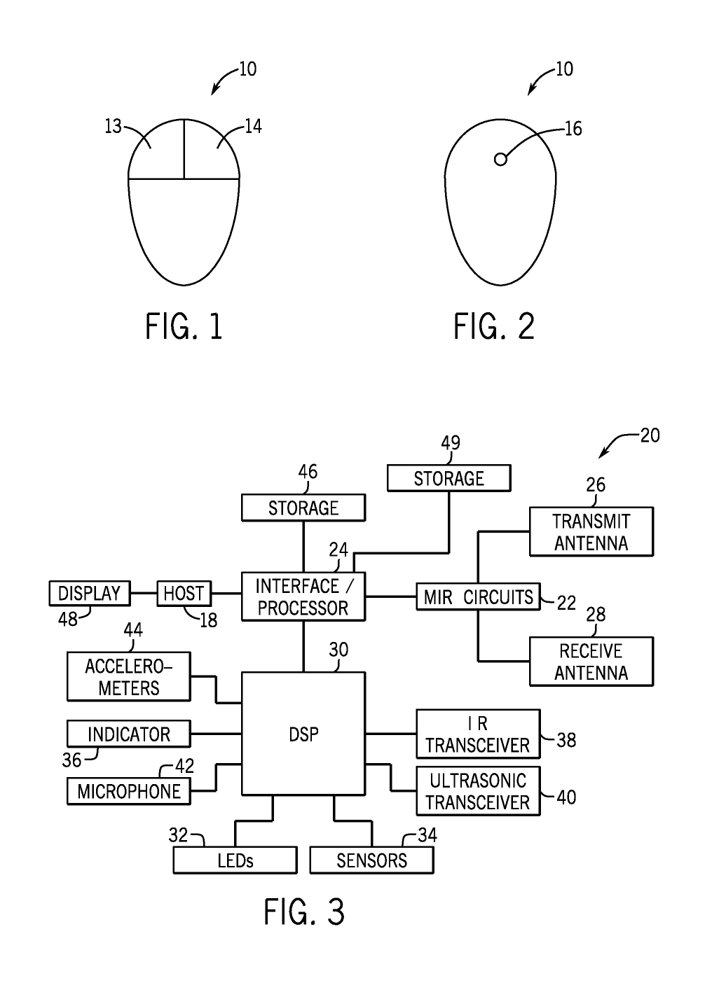

Referring to FIG. 1, one embodiment of a scanning wand 10 includes a top surface, two buttons 13 and 14 positioned to be activated by the index, middle and/or ring fingers, in one embodiment, while the wand fits in the user's palm. A wand sensor 16 shown in FIG. 2, may include one or more light emitting diode (LED)/sensor pairs on the bottom of the wand 10. In some embodiments more transmitter/sensor pairs may be provided. In addition, other transmitter/sensor groups, including ultrasonic and infrared transceivers, may be used to provide additional information for use in determining the exact position, speed and direction of movement of the wand.

Referring to FIG. 3, in one embodiment, an interface and/or processor 24 may be used to connect the wand hardware 20 to a host processor-based system 18 such as a laptop or desktop computer to mention two examples. The interface between the host and the processor 24 may be wired or wireless. In one embodiment it may a universal serial bus (USB) connection that supplies power to the hardware 20. A Bluetooth wireless connection may be used in one embodiment.

The processor 24 receives the inputs from the micro impulse radar (MIR) circuits 22. These circuits are connected to a MIR transmit antenna 26 and one or more MIR receive antennae 28. An additional antenna may be used to detect live wire emissions (typically 50 or 60 Hz) for purposes of live wire warning. A single coil antenna may be used, for example. Still another antenna may detect a magnetic field indication of steel based pipe or conduit versus non-ferrous pipes.

The interface and processor 24 may receive inputs from a digital signal processor (DSP) 30. The processor 30 processes the generation of light pulses from LEDs 32 and the receipt of reflections from the scanned surface, detected by sensors 34. Thus in some embodiments, a pair of an LED 32 and sensor 34 may implement the transceiver 16 shown in FIG. 1. In addition, the processor 30 may operate an indicator 36 to indicate when the wand is being moved too slowly or too quickly along the wall. It may also indicate if the wand is too far away from the wall in some embodiments or too close to the wall in some embodiments. A microphone 42 may provide information about sound, such as water movements or animal sounds, within the wall.

An infrared transceiver 38 may be used to gain additional information about what is inside the wall by transmitting infrared pulses and detecting infrared signals reflected back to the wand. Likewise an ultrasonic transceiver 40 may be used for the same purposes.

A user may perform a scan by moving the wand in a serpentine pattern across the surface to be analyzed. Because of the optical scanning provided by the LEDs 32 and sensors 34, movement in two dimensions may be detected. Information from accelerometers and/or gyroscopes 44 may be used to further augment and confirm rate of speed, initiation of movement, rotation, and changes of direction.

Through the use of optical scanning, augmented with other circuits as needed, the system calculates the distance between scanned rows. For example, the user may start at the upper left corner of a region to be scanned, move right to an upper right corner and then slide down a short distance and then slide the wand back to the left side, then slide down then back to the right. Each of these horizontal scans may be separated by a distance and it may be desirable, when displaying the scan results, to correctly position the images from each horizontal scan in their correct physical orientation relative to other horizontal scans.

In some embodiments, the user does not have to make perfect horizontal or vertical movement. The only adverse effect would be a final image that is not perfectly rectangular in some embodiments. But this generally should be acceptable as the user may only be interested in the central part of the scanned area.

There are a variety of ways to transfer the data between the wand and the host and to display the information on the host display 48. In a first embodiment the display may display in real time so that data is scanned by the wand and sent to the computer and the computer updates the visual display so that the user can see the row that was just scanned as well as any prior scans. In another embodiment, the remote display is not updated until all the rows have been scanned and the wand is stationary, for example. In still another embodiment, data may be stored locally within the wand until the scan is complete. For example, a user may push a button 13 or 14 or otherwise operate an input to begin and end a scan. Then the data may be transferred when the off button is operated. In other embodiments, the display may be incorporated into the wand.

A storage 46 may be any kind of conventional storage or memory to store scan data.

The interface between the wand and the computer may be a wired or wireless interface including a universal serial bus peripheral that enables a wand to draw power from the host via the USB cable. In other embodiments, the wand may be wireless and may run from an internal battery using Bluetooth, WiFi, or other wireless technology to communicate with the host.

In order to maintain a desired number of MIR pulses per wand distance travelled, an indication may be provided to the user if moving the wand too quickly (which generally is greater than 100 millimeters per second in some embodiments). The indicator 36 may be a light indicator, an audible indicator or a tone generated from the host computer in some embodiments.

Additional information from microphone 42 may be used to listen for sounds within the wall including leaking pipes, animals, or insects, rattling air conduits and the like. An infrared transceiver 38 may act as a thermometer to measure the wall temperature to gain information about operating units or to distinguish between hot and cold water lines. An optional ultrasonic transceiver 40 measures distance from the wand to the floor, which may be helpful in cases for precise mapping of the wall.

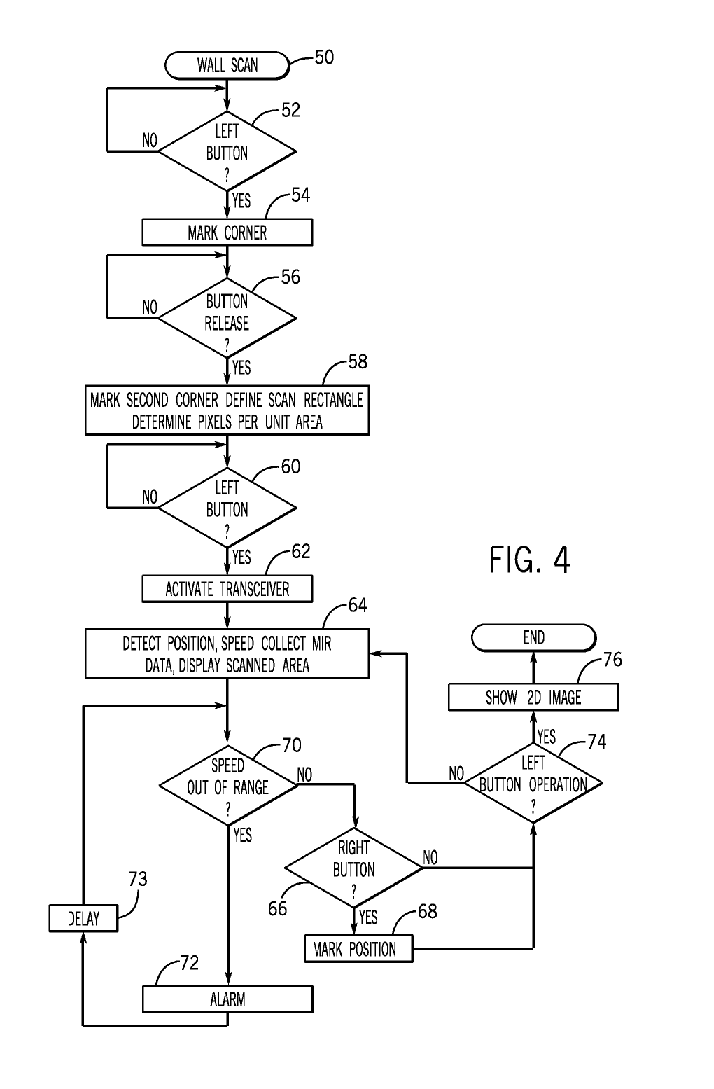

Referring to FIG. 4, a sequence 50 for scanning using micro impulse radar may be implemented in software, firmware and/or hardware. In software and firmware embodiments it may be implemented by computer executed instructions stored in one or more non-transitory computer readable media such as magnetic, optical, or semiconductor storages. In some embodiments it may be implemented by a remote host and in other embodiments it may be implemented by the processor 24 and the sequence in the form of computer executed instructions may be stored in the processor 24 or in the storage 46 to mention two examples.

The sequence begins by detecting actuation of a button such as the button 13 in FIG. 1 by the user's index finger as indicated in diamond 52. Of course while a left button is shown as being actuated other actuations could also be provided including a right button actuation. In addition, other input devices such as a touch screen could also be used, a button on a keyboard, or even a gesture such as moving the wand repeatedly to the left and the right.

The detection of a left button actuation in diamond 52 may be used to mark the upper left corner of a rectangular area to be scanned as indicated in block 54. In some embodiments, a rectangular region of a wall may be scanned and the region that will be scanned may be marked by operating one button, such as the left button, at the upper left hand corner of the region and releasing the button in the lower right hand corner of the region to be scanned. In this way, the system can learn what are the coordinates of a rectangular area to be scanned. Other techniques may also be used including marking each of the vertices of a polygon to be scanned by repeatedly operating buttons to indicate those vertices.

In one embodiment when a button release is detected, as indicated in diamond 56, the second corner is thereby indicated. Then the system marks the second corner and defines the scan rectangle as indicated in block 58 in one embodiment. The system can also determine the number of pixels per unit area to be scanned. Based on information about the available screen size and now knowing the area to be scanned, the correlation between pixels and scanned area can be set.

When the left button is again pressed, as indicated in diamond 60 in one embodiment, the MIR transceiver may be activated as indicated in block 62. Again, other input indications can be used to start the scanning sequence including operating different buttons, operating different input devices and using gestural indications involving movement of the wand 10. Once the transceiver is activated, the position and speed of the wand are monitored, as indicated in block 64, using the optical transceiver pair 16 (FIG. 2). Thus the data is collected about where the wand is at any instant of time. This information may be correlated to the scanned image data that is coming in. For example, the scanned data may be annotated with headers that indicate the corresponding position to facilitate assembly of the data according to scanned location.

At the same time, a host display screen 48 (FIG. 3) may change color to indicate a portion of the to be scanned rectangle that has now been scanned. For example, as the wand is moved over an area, that area may change color on the display screen even if the display screen has not yet actually displayed the actual image data. This enables the user to get some feedback that ensures that the desired area is completely scanned and that nothing is missed.

A check at diamond 70 determines whether the speed of movement of the wand is out of range. In some embodiments, the number of pulses that are produced by the MIR transmitter may be fixed and therefore when the wand is moved too quickly, sufficient scan data may not be obtained. Thus it may be desirable to provide an indication to the user that the user is scanning too quickly and that the resulting depiction will be degraded. Likewise when the user is moving the wand too slowly, the user may wish to be advised to speed up the scanning without degrading the quality of the ultimate depiction.

If the speed is out of range, an alarm can be issued as indicated in block 72. The alarm may be an audible beep which is faster if the user is moving too fast and slower if the user is moving too slow or it may be a light indication such as a pulsing light that is pulsing faster if moving too fast and pulsing slower if the user is moving to slow, as two examples. In addition, an indication may be provided on the screen display which instead of indicating that an area over which the wand has been moved was scanned on the screen display, the improperly scanned area may be indicated as not scanned in a variety of fashions, including using a different color for that area. After a delay (block 73) the flow rechecks whether the speed is out of range.

If the speed is not out of range, a check at diamond 66 determines whether the right button 14 has been operated. If so, the position of the wand at that instant is marked (block 68). Marking the position indicates that the coordinates in 2D space are recorded so that location within the scanned rectangle can be indicated on the display. Once its position relative to the rest of the scanned rectangle is known, this information can be used to indicate relative distances from that particular marked location to different objects that are ultimately detected in the scan. For example, the distance from the marked point can be indicated in the ultimate scan as a distance indicator showing the physical distance from a pipe that was recognized in the wall to the marked location. This will facilitate taking measurements to correlate these distances on the wall and in some cases to avoid hazards such as cutting electrical lines or pipes or other elements.

Next, a check at diamond 74 determines whether the left button has been pressed again. If so, the 2D image is assembled and displayed (block 76). The micro impulse radar data is received and if desired, transmitted to the host 58. In such case, the system reconstructs the entire rectangular image based on the positions of scanned data and displays the data in the proper positions. Where the same area has been repeatedly scanned, this is accounted for in the display without duplication. If any areas were missed, they can be shown as blank areas. All the scan data is then positioned within the displayed rectangle which represents a scaled depiction of the original rectangle to be scanned.

If an area was marked for example by operating the right button, that area will be indicated by a plus sign or other icon on the screen. Then arrows show the distance from that plus sign or other icon to all the objects that were actually detected. For example if electrical lines, pipes, and other items are detected, the shortest distance from that icon to those objects may be displayed. In some embodiments, a light or semitransparent grid may be displayed over the entire depiction to give real world distances from left to right and top to bottom across the displayed rectangle.

If a subsequent operation of the left button is not detected, as determined in diamond 74, the flow iterates, looking for the left button press, watching for right button actuation and detecting any out of range speeds of movement. The wand movement may be detected by accelerometers, the LED sensor system, or by any other technique.

In one embodiment, the micro impulse radar pulses are activated only when wand movement is detected. This may be done using accelerometers alone or the optical positional system or by any other technology.

Then when it is desired to display the data, it can be provided in a two dimensional display that realistically shows exactly where the wand was when the data was collected. In some embodiments, more than a serial wand display may be provided, and instead the exact pattern of movement of the wand and the results of the movement in terms of detected features, may be displayed on a display that correlates with the wand position. In some cases, a display image may move with the wand and in other cases it may be a static display that shows the results of a scan of predetermined time or a scan marked by on and off indications from the user as another example.

The following clauses and/or examples pertain to further embodiments:

One example embodiment may be an apparatus comprising a housing. The apparatus may include a micro impulse radar transceiver in said housing and a device to identify at least two locations of said transceiver, and to determine a two dimensional scan area from those locations. The apparatus may also include an optical transceiver mounted on said housing. The apparatus may also automatically determine for the scan area defined by said two locations, a number of pixels per unit of scan area. The apparatus may also include a microphone in said housing. The apparatus may also include an infrared transceiver in said housing. The apparatus may also correlate transceiver position with a radar signal received by said transceiver and to display radar images in a scaled two dimensional representation of said scan area. The apparatus may also include an ultrasonic transceiver. The apparatus may also include a sensor to indicate speed of movement of said transceiver. The apparatus may also include an indicator to indicate when said transceiver is moved over said wall too fast. The apparatus may also include a pair of user operable buttons on said housing, including a button to enable a user to indicate said locations.

Another example may be a method comprising identifying at least two locations of a micro impulse radar transceiver and determining a two dimensional scan area from those locations. The method may also include using an optical transceiver to identify said two locations. The method may also include automatically determining for the scan area defined by said two locations, a number of pixels per unit of scan area. The method may also include correlating transceiver position with a radar signal received by said transceiver and displaying radar images in a scaled two dimensional representation of said scan area. The method may also include determining speed of movement of said transceiver. The method may also include indicating when said radar is moved over a surface too fast. The method may also include monitoring a pair of user operable buttons on said transceiver, including a button to enable a user to indicate said locations. The method may also include recording said two locations to define a rectangular scan area. The method may also include recognizing an input from one button as a signal to mark a rectangle and receiving a signal from the other button to indicate a command to display an image. The method may also include recognizing a button operation as a command to mark on a display the location overlaid by said transceiver when said button was operated.

In another example, one or more non-transitory computer readable media may store instructions to cause one or more processors to perform a sequence comprising identifying at least two locations of a micro impulse radar transceiver and determining a two dimensional scan area from those locations. The media may further store instructions including using an optical transceiver to identify said two locations. The media may further store instructions including automatically determining for the scan area defined by said two locations, a number of pixels per unit of scan area. The media may further store instructions including correlating transceiver position with a radar signal received by said transceiver and displaying radar images in a scaled two dimensional representation of said scan area. The media may further store instructions including determining speed of movement of said transceiver. The media may further store instructions including indicating when said radar is moved over a surface too fast. The media may further store instructions including monitoring a pair of user operable buttons on said transceiver, including a button to enable a user to indicate said locations. The media may further store instructions including recording said two locations to define a rectangular scan area. The media may further store instructions including recognizing an input from one button as a signal to mark a rectangle and receiving a signal from the other button to indicate a command to display an image. The media may further store instructions including recognizing a button operation as a command to mark on a display the location overlaid by said transceiver when said button was operated.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this disclosure.

What is claimed is:

1. An apparatus comprising:
a housing;
a micro impulse radar transceiver in said housing; and
a device to identify at least two locations of said transceiver, and to determine a two dimensional scan area from those locations.

2. The apparatus of claim 1 wherein said device includes an optical transceiver mounted on said housing.

3. The apparatus of claim 1 to automatically determine for the scan area defined by said two locations, a number of pixels per unit of scan area.

4. The apparatus of claim 1 including a microphone in said housing.

5. The apparatus of claim 1 including an infrared transceiver in said housing.

6. The apparatus of claim 1 said device to correlate transceiver position with a radar signal received by said transceiver and to display radar images in a scaled two dimensional representation of said scan area.

7. The apparatus of claim 1 including an ultrasonic transceiver.

8. The apparatus of claim 1 including a sensor to indicate speed of movement of said transceiver.

9. The apparatus of claim 1 including an indicator to indicate when said transceiver is moved over said wall too fast.

10. The apparatus of claim 1 including a pair of user operable buttons on said housing, including a button to enable a user to indicate said locations.

11. A method comprising:
identifying at least two locations of a micro impulse radar transceiver; and
determining a two dimensional scan area from those locations.

12. The method of claim 11 including using an optical transceiver to identify said two locations.

13. The method of claim 11 including automatically determining for the scan area defined by said two locations, a number of pixels per unit of scan area.

14. The method of claim 11 including correlating transceiver position with a radar signal received by said transceiver and displaying radar images in a scaled two dimensional representation of said scan area.

15. The method of claim 11 including determining speed of movement of said transceiver.

16. The method of claim 11 including indicating when said radar is moved over a surface too fast.

17. The method of claim 11 including monitoring a pair of user operable buttons on said transceiver, including a button to enable a user to indicate said locations.

18. The method of claim 17 including recording said two locations to define a rectangular scan area.

19. The method of claim 18 including recognizing an input from one button as a signal to mark a rectangle and receiving a signal from the other button to indicate a command to display an image.

20. The method of claim 18 including recognizing a button operation as a command to mark on a display the location overlaid by said transceiver when said button was operated.

21. One or more non-transitory computer readable media storing instructions to cause one or more processors to perform a sequence comprising:
identifying at least two locations of a micro impulse radar transceiver; and
determining a two dimensional scan area from those locations.

22. The media of claim 21, said sequence including using an optical transceiver to identify said two locations.

23. The media of claim 21, said sequence including automatically determining for the scan area defined by said two locations, a number of pixels per unit of scan area.

24. The media of claim 21, said sequence including correlating transceiver position with a radar signal received by said transceiver and displaying radar images in a scaled two dimensional representation of said scan area.

25. The media of claim 21, said sequence including determining speed of movement of said transceiver.

26. The media of claim 21, said sequence including indicating when said radar is moved over a surface too fast.

27. The media of claim 21, said sequence including monitoring a pair of user operable buttons on said transceiver, including a button to enable a user to indicate said locations.

28. The media of claim 27, said sequence including recording said two locations to define a rectangular scan area.

29. The media of claim 28, said sequence including recognizing an input from one button as a signal to mark a rectangle and receiving a signal from the other button to indicate a command to display an image.

30. The media of claim 28, said sequence including recognizing a button operation as a command to mark on a display the location overlaid by said transceiver when said button was operated.
